(19) United States
(12) Patent Application Publication
(10) Pub. No.: US 2014/0023453 A1
(43) Pub. Date: Jan. 23, 2014

(54) WIRE THREAD INSERT

(71) Applicant: Alan HOLLENSEN, Rowville (AU)

(72) Inventor: Alan HOLLENSEN, Rowville (AU)

(21) Appl. No.: 13/555,488

(22) Filed: Jul. 23, 2012

(51) Int. Cl. F16B 37/12

(52) U.S. Cl. 411/178; 411/438

(57) ABSTRACT

A wire thread insert including a body having a leading end and a trailing end, a first segment having a first plurality of coils and a first diameter, and a second segment having at least one coil and a second diameter. The second diameter of the second segment is greater than the first diameter of the first segment. A bolt threadedly engages the insert, and the bolt/insert assembly threadedly engages a hole of a workpiece. When the bolt/insert assembly is installed into the hole, the at least one coil expands diametrically outwardly into the internal threads of the hole so that the at least one coil remains seated therein. The bolt is removable while the insert remains within the hole.

### FIELD OF THE INVENTION

The present invention relates to a wire thread insert, and, more particularly, to a wire thread insert for engaging tapped threads of a workpiece.

### BACKGROUND OF THE INVENTION

When the threads of a threaded hole in a workpiece (i.e., a plate, nut, engine head, boss, etc.) become worn, cross-threaded or damaged, they cleared by drilling the threaded hole with a drill bit that has a diameter that is at least equal to the diameter of the major diameter of the damaged threads. The hole is then tapped with new threads. Since the diameter of the new threads is larger than the diameter of the original damaged threads, it is necessary to install a wire thread insert into the tapped threads, so that a bolt, spark plug, or other element that is sized to fit the original threads will be able to be screwed into the new threads of the workpiece.

### SUMMARY OF THE INVENTION

In an embodiment, a wire thread insert including a body having a leading end and a trailing end opposite the leading end, a first segment having a first plurality of coils and a first diameter, and a second segment having at least one coil and a second diameter, wherein the first segment extends from the leading end to a point intermediate the leading end and the trailing end, and the second segment extends from the first segment to the trailing end, and wherein the second diameter of the second segment is greater than the first diameter of the first segment. In an embodiment, the at least one coil includes a second plurality of coils.

In an embodiment, the wire thread insert is adapted to threadedly engage a bolt to form a bolt/insert assembly. In an embodiment, the bolt includes external threads that threadedly engage the first plurality of coils and the at least one coil of the wire thread insert. In an embodiment, the sum of the number of the first plurality of coils and the number of the at least one coil is equal to the number of the external threads of the bolt. In an embodiment, the sum of the number of the first plurality of coils and the number of the at least one coil is less than the number of the external threads of the bolt. In an embodiment, the external threads of the bolt include a third diameter that is larger than the first diameter of the first segment, wherein the external threads of the bolt expands the first plurality of coils diametrically outwardly.

In an embodiment, the bolt/insert assembly is adapted to threadedly engage a hole of a workpiece. In an embodiment, the hole of a workpiece includes internal threads having a fourth diameter. In an embodiment, the second diameter of the second segment is larger than the fourth diameter of the internal threads of the hole, and wherein when the bolt/insert assembly is installed into the hole of the workpiece, the second diameter of the second segment is temporarily narrowed. In an embodiment, the bolt/insert assembly is fully installed within the hole of the workpiece, the at least one coil expands diametrically outwardly into the internal threads of the hole so that the at least one coil remains seated therein. In an embodiment, the bolt is adapted to be removable from the bolt/insert assembly when installed within the hole, and the insert is adapted to remain in the hole when the bolt is removed.

### BRIEF DESCRIPTION OF THE DRAWINGS

For a more complete understanding of the present invention, reference is made to the following detailed description of an exemplary embodiment considered in conjunction with the accompanying drawings, in which:

FIG. 1 is a perspective view, taken from a trailing edge, of a wire thread insert constructed in accordance with an embodiment of the present invention;

FIG. 2 is perspective view, taken from a leading edge, of the wire thread insert shown in FIG. 1;

FIG. 3 is a cross-sectional view of the insert shown in FIGS. 1 and 2, taken along section line 3-3 of FIG. 2, and looking in the direction of the arrows;

FIG. 4 is perspective view of the insert shown in FIGS. 1-3, wherein the insert is shown positioned adjacent to a bolt and a workpiece having a tapped hole;

FIG. 5 is a cross-sectional view of an assembly of the bolt and the insert shown in FIG. 4, wherein the bolt is shown fully screwed into the insert;

FIG. 6 is a cross-sectional view of the assembly of the bolt and the insert, wherein the assembly of the bolt and the insert is shown fully screwed into the tapped hole of the workpiece; and

FIG. 7 is a cross-sectional view of the insert shown fully screwed into the tapped hole of the workpiece, and the bolt is shown partially screwed out of the tapped hole.

### DETAILED DESCRIPTION OF THE EXEMPLARY EMBODIMENT

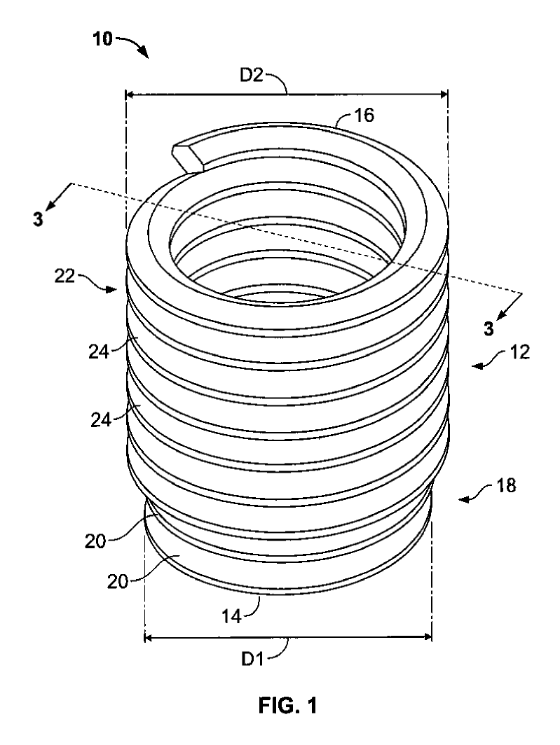

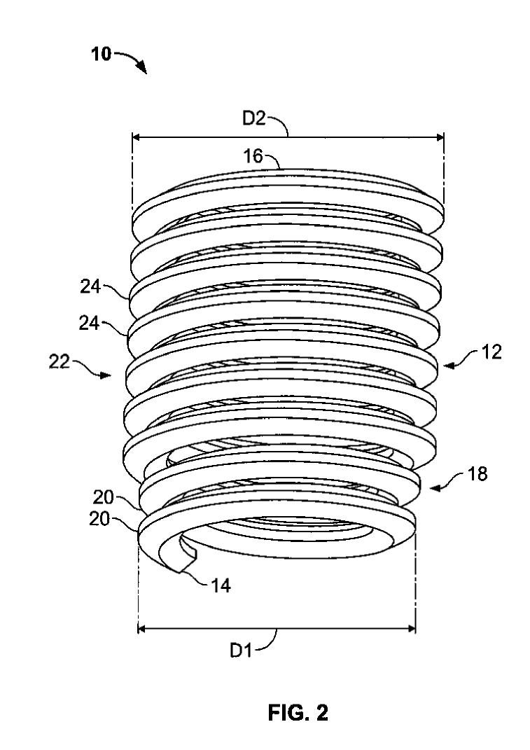

FIGS. 1 and 2 illustrate a wire thread insert 10 (hereinafter “the insert 10”) that is constructed in accordance with an embodiment of the present invention. In an embodiment, the insert 10 includes a body 12 having a leading end 14 and a trailing end 16 that is located opposite the leading end 14. In an embodiment, the body 12 includes a first segment 18 having a first plurality of coils 20 that extends from the leading end 14 of the body 12 to a point intermediate the leading end 14 and the trailing end 16 of the body 12, and a second segment 22 having a second plurality of coils 24 that extends from the first segment 18 to the trailing end 16. In an embodiment, the first segment 18 includes at least one coil 20. In an embodiment, the first segment 18 has a diameter D1, while the second segment 22 has a diameter D2. In an embodiment, the diameter D2 exceeds the diameter of a tapped hole in a workpiece, which is described hereinbelow. In an embodiment, the diameter D2 of the second segment 22 is greater than the diameter D1 of the first segment 18, for purposes that are described hereafter.

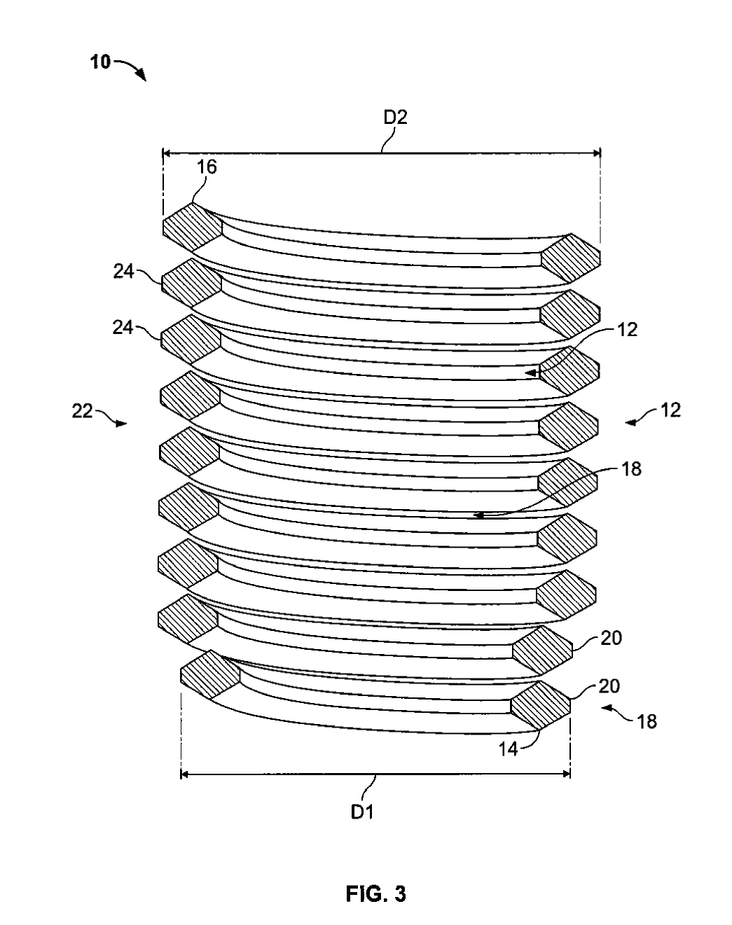

FIG. 3 illustrates a diamond-like cross-sectional shape of the first and second plurality of coils 20, 24 of the insert 10. In an embodiment, the insert 10 is fabricated in a conventional manner and is made from a conventional material, such as metal.

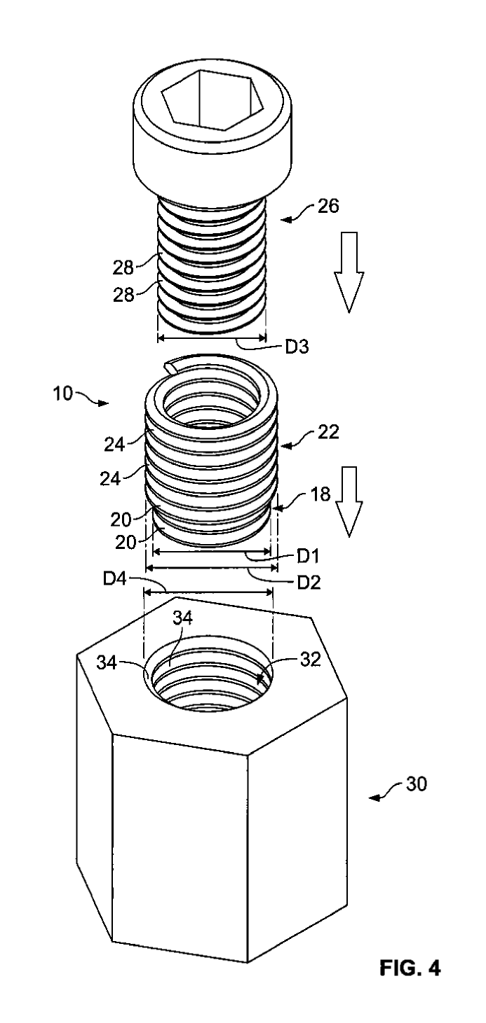

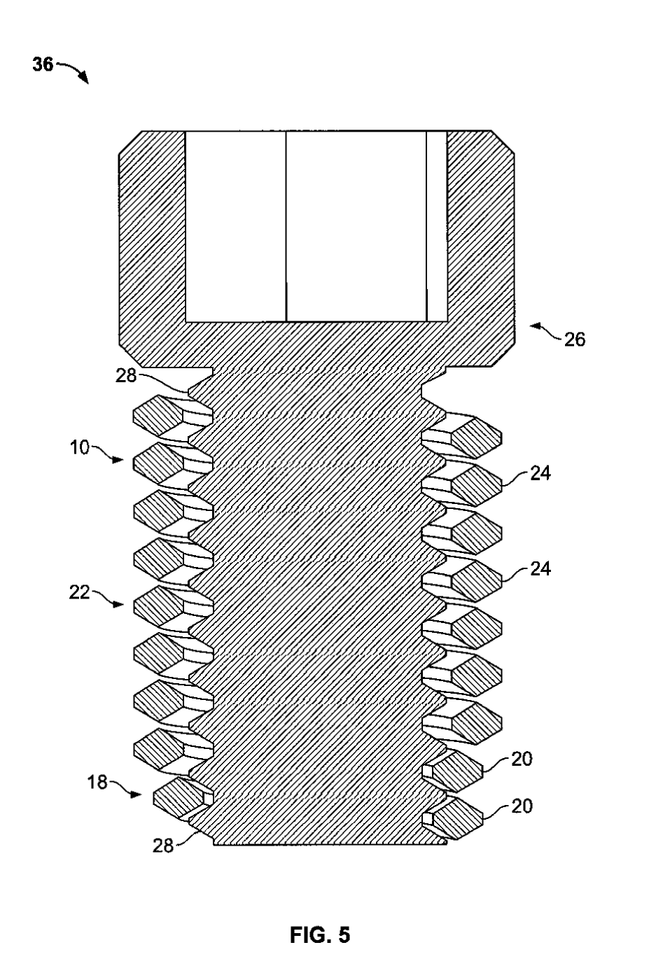

Referring to FIG. 4, in operation, the insert 10 is shown positioned adjacent to a bolt 26, which has external threads 28 having a diameter D3, and a workpiece 30, which has a hole 32 with tapped internal threads 34 having a diameter D4. In an embodiment, the insert 10 is installed in the hole 32 of the workpiece 30 in a manner which includes the following steps. First, the insert 10 is fully wound onto the bolt 26 to form a bolt/insert assembly 36 (see FIG. 5). In an embodiment, a tool (not shown) may be used to facilitate the winding of the insert 10 onto the bolt 26. More particularly, in an embodiment, the insert 10 is wound onto the bolt 26, wherein the threads 28 of the bolt 26 engage the coils 24, until the leading end 24 winds down to the coils 20 of the first segment 18 and tightens. In an embodiment, the sum of the number of coils 20 of the first segment 18 plus the number of coils 24 of the second segment 22 is equal to the number of threads 28 of the bolt 26. In an embodiment, the sum of the number of coils 20 of the first segment 18 plus the number of coils 24 of the second segment 22 is less than the number of threads 28 of the bolt 26. In an embodiment, as the insert 10 is wound onto the bolt 26, the coils 20 of the first segment 18 are forced to expand diametrically outwardly because the diameter D3 of the threads 28 of the bolt 26 is larger than the diameter D1 of the coils 20. In an embodiment, the coils 20 become locked torsionally on the threads 28 of the bolt 26, and form the bolt/insert assembly 36 which is ready for installation in the hole 32 of the workpiece 30.

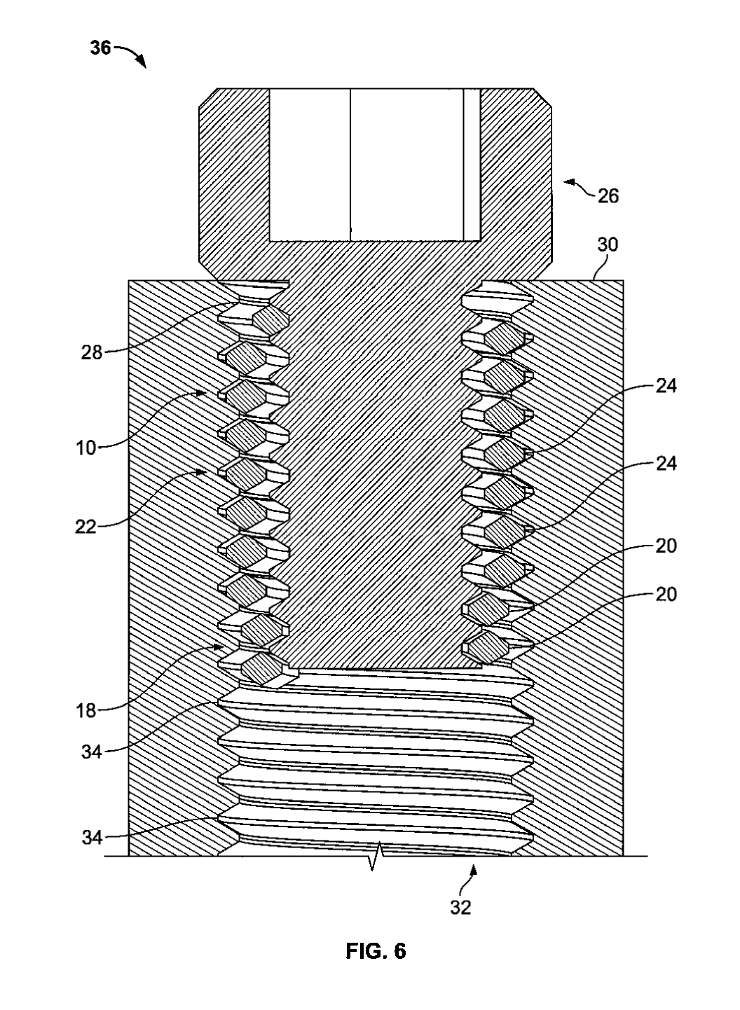

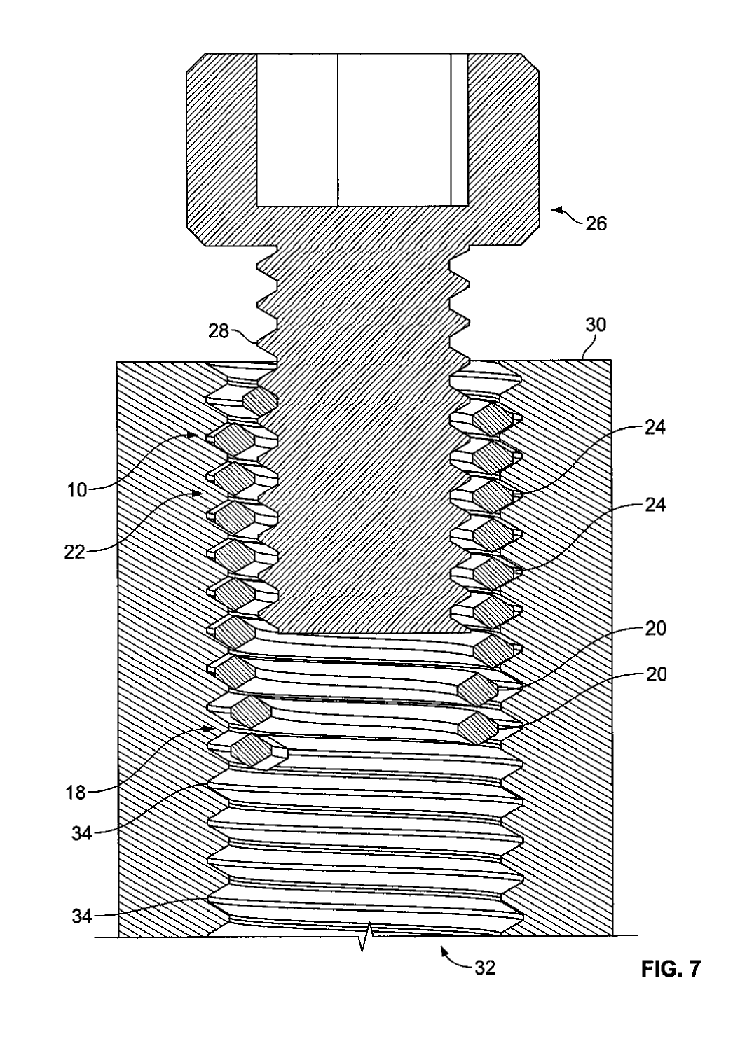

Next, in an embodiment, the leading end 14 of the bolt/insert assembly 36 is positioned on one of the tapped threads 34 that is proximate to the opening of the hole 32. In an embodiment, torque is applied to the head of the bolt 26 by a tool, such as a torque-wrench, and torque is applied on the bolt/insert assembly 36. In an embodiment, the bolt/insert assembly 36 is wound into the hole 32 until a predetermined application-torque achieved, at which point the insert 10 is fully installed in the hole 32 of the workpiece 30 (see FIG. 6). More particularly, in an embodiment, since the coils 20 of the first segment 18 clasp the threads 28 of the bolt 26 as the bolt/insert assembly 36 is screwed into the threads 34 of the tapped hole 32, the coils 24 of second segment 22 are wound onto the threads 34 of the hole 32. In an embodiment, as the coils 24 of second segment 22 are wound onto the threads 34 of the hole 32, dynamic friction between the coils 24 and the threads 34 tightens and temporarily narrows the diameter D2 of the coils 24. Once the bolt/insert assembly 36 is fully wound onto the threads 34 of the hole 32 (i.e., the predetermined application-torque is achieved), the torque is no longer applied, and the dynamic friction between the coils 24 and the threads 34 is terminated. In an embodiment, the coils 24, therefore, expand outwardly into the threads 34 of the hole 32. In an embodiment, since the diameter D2 of the coils 24 is slightly larger than the diameter D4 of the tapped hole 32, the coils 24 remain firmly seated in the threads 34 of the hole 32. In an embodiment, the bolt 26, which is now fully installed in the hole 32, may be wound out of and into the hole 32 at will, while the insert 10 remains fully installed the hole 32. FIG. 7 depicts the bolt 26 partially wound out of the hole 32 of the workpiece 30, and the insert 10 fully installed in the hole 32.

In an embodiment, the fabrication of the insert 10 eliminates the cost of forming a tang and a break-point. In an embodiment, the installation of the insert 10 eliminates time consuming steps of using a special installation tool to screw the insert 10 into the workpiece 30, and breaking off the tang so that the bolt may subsequently be screwed into the hole 32. In an embodiment, the insert 10 and the bolt 26 are installed together in the tapped hole 32 of the workpiece 30 in one step.

In an embodiment, the insert 10 is adapted to be used in connection with bolts or pin members. In an embodiment, the insert 10 is adapted to be used in connection with spark plugs.

It will be understood that the embodiment described herein is merely exemplary and that a person skilled in the art may make many variations and modifications without departing from the spirit and scope of the invention. All such variations and modifications are intended to be included within the scope of the invention as defined in the appended claims.

What is claimed is:

1. A wire thread insert, comprising:
a body having a leading end and a trailing end opposite the leading end, a first segment having a first plurality of coils and a first diameter, and a second segment having at least one coil and a second diameter,
wherein the first segment extends from the leading end to a point intermediate the leading end and the trailing end, and the second segment extends from the first segment to the trailing end, and
wherein the second diameter of the second segment is greater than the first diameter of the first segment.

2. The wire thread insert of claim 1, wherein the wire thread insert is adapted to threadedly engage a bolt to form a bolt/insert assembly.

3. The wire thread insert of claim 2, wherein the bolt includes external threads that threadedly engage the first plurality of coils and the at least one coil of the wire thread insert.

4. The wire thread insert of claim 3, wherein the sum of the number of the first plurality of coils and the number of the at least one coil is equal to the number of the external threads of the bolt.

5. The wire thread insert of claim 3, wherein the sum of the number of the first plurality of coils and the number of the at least one coil is less than the number of the external threads of the bolt.

6. The wire thread insert of claim 3, wherein the external threads of the bolt include a third diameter that is larger than the first diameter of the first segment, wherein the external threads of the bolt expands the first plurality of coils diametrically outwardly.

7. The wire thread insert of claim 6, wherein the bolt/insert assembly is adapted to threadedly engage a hole of a workpiece.

8. The wire thread insert of claim 7, wherein the hole of a workpiece includes internal threads having a fourth diameter.

9. The wire thread insert of claim 8, wherein the second diameter of the second segment is larger than the fourth diameter of the internal threads of the hole, and is wherein when the bolt/insert assembly is installed into the hole of the workpiece, the second diameter of the second segment is temporarily narrowed.

10. The wire thread insert of claim 9, wherein when the bolt/insert assembly is fully installed within the hole of the workpiece, the at least one coil expands diametrically outwardly into the internal threads of the hole so that the at least one coil remains seated therein.

11. The wire thread insert of claim 10, wherein the bolt is adapted to be removable from the bolt/insert assembly when installed within the hole, and the insert is adapted to remain in the hole when the bolt is removed.

12. The wire thread insert of claim 1, wherein the at least one coil includes a second plurality of coils.
